(19) United States
(12) Patent Application Publication
(10) Pub. No.: US 2016/0116298 A1
(43) Pub. Date: Apr. 28, 2016

(54) SYSTEM AND METHOD FOR USING AUDIBLE WAYPOINTS IN MOBILE NAVIGATION

(71) Applicant: LEADNAV SYSTEMS, LLC, MOYOCK, NC (US)

(72) Inventors: DAMIAN CLAPPER, MOYOCK, NC (US); BRAD VANMIDDLESWORTH, MOYOCK, NC (US)

(21) Appl. No.: 14/919,311

(22) Filed: Oct. 21, 2015

Related U.S. Application Data
(60) Provisional application No. 62/068,086, filed on Oct. 24, 2014.

(51) Int. Cl. G01C 21/36; H04W 4/00; H04W 76/02; G01S 19/42

(52) U.S. Cl. CPC G01C 21/3629; G01C 21/3667; G01C 21/3608; G01S 19/42; H04W 4/008; H04W 76/023; H04W 84/12

(57) ABSTRACT

A mobile navigation device for generating and using audible waypoints in the context of navigating a route, course, or path. An embodiment of the device includes a processor configured to facilitate generation of an audible waypoint. An audible waypoint may be a marker associated with a specific location on a map that not only includes information the physical location but is also associated with an audio file. Thus, when the user navigates to the audible waypoint coordinates, then the audio file associated with the audible waypoint may be played back. The device includes a microphone configured to receive audio (e.g., the sound of the voice of the user) such that the processor stores a recorded audio file in memory. Further, the device includes an audio output, such as a speaker, to playback the audio file in coordination with the navigation application when a trigger condition is met.

### PRIORITY CLAIM

This application claims the benefit of U.S. Provisional Application No. 62/068,086, entitled “System and Method for Mobile Navigation Manipulation,” filed Oct. 24, 2014, which is incorporated herein by reference in its entirety for all purposes.

### BACKGROUND

Mobile navigation devices introduce a great number of freedoms and computing capabilities to people on the go such that information may be sought and retrieved via wireless network connections to many other computer systems and generally, the Internet. To this end, mobile navigation devices are widely used as navigation devices for individuals that may need access to maps and directions while away from a typical stationary computing device. In this manner, one is no longer tied to the wire, so to say. As a result, mobile navigation devices allow users to navigate in many areas and locations by wirelessly accessing global position system (GPS) data from a network of interconnected computing devices and servers.

However, as the delivery of more and more data at faster rates of data delivery is available, additional features and uses of mobile navigation become a reality. Conventional mobile navigation systems have focused on providing map and location data as well as turn-by-turn directions to a user in a relatively one-way interactive manner. That is, after a user inputted by keystroke specific destination data, the navigation system would then calculate a route and provide data to the user as developed through a route building routine. This is often by design as a driver of a vehicle should not be distracted while driving in order to provide further input (keystrokes) to the mobile navigation system. Thus, a problem with many conventional mobile navigation programs and applications is the distinct lack of interactive features, such as, for example, the use of audio input and output during navigation.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is diagram of a user operating a vehicle and using a mobile navigation device according to an embodiment of the subject matter disclosed herein.

FIG. 2 is a diagram of a suitable system in which the mobile navigation device of FIG. 1 may operate according to an embodiment of the subject matter discussed herein.

FIG. 3 is a screen shot of a mobile navigation application executing on the mobile navigation device of FIG. 1 according to an embodiment of the subject matter discussed herein.

FIG. 4 is a screen shot of a mobile navigation application executing on the mobile navigation device of FIG. 1 showing audible waypoint markers according to an embodiment of the subject matter discussed herein.

FIG. 5 is a flow chart of a method for operating the mobile navigation device of FIG. 1 to establish an audible waypoint according to an embodiment of the subject matter discussed herein.

FIG. 6 is a flow chart of a method for operating the mobile navigation device of FIG. 1 to invoke an audible waypoint according to an embodiment of the subject matter discussed herein.

FIG. 7 is a diagram of a suitable computing device and environment for practicing various aspects and embodiments of the systems and methods of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

Prior to providing a detailed description of various embodiments with respect to the figures, an overview of the subject matter is discussed next. Embodiments discussed herein include a mobile navigation device and a navigation system (and methods of use thereof) that allow a user to interact with the device and the system to generate audible waypoints in the context of navigating a route, course or path. An embodiment of the mobile navigation device includes a memory having computer-executable instructions that can be executed by a processor to present a user with an application for mobile navigation. Thus, a display may show a map of a local area (localized around the physical location of the device) along with an indication of the location of the device as well as input options for manipulating the mobile navigation application.

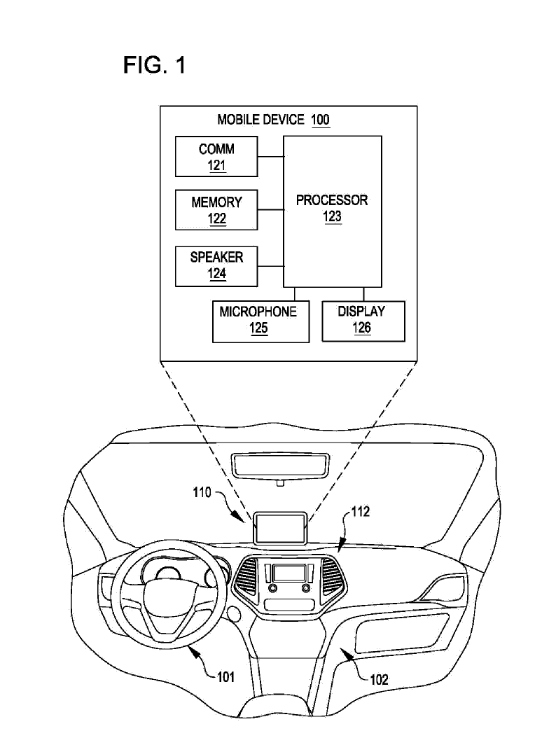

One such input option includes a process for generating an audible waypoint. An audible waypoint may be a marker associated with a specific location on a map that not only includes information about a longitudinal and latitudinal coordinates but is also associated with an audio file of the user's choosing. Thus, when the user (having the mobile navigation device) navigates to the audible waypoint coordinates, then the audio file associated with the audible waypoint may be played back. To realize this functionality, the mobile navigation device includes a microphone coupled to the processor that is configured to receive analog audio signals (e.g., the sound of the voice of the user) such that the processor is configured to use a locally executing program to translate the voice input to text and store the text created in a text file in the memory. In other embodiments, the processor is configured to store one or more recorded analog audio signals an audio file in the memory. Further, the mobile navigation device includes an audio output, such as a speaker, to playback the text file (in a text-to-speech engine) or audio file in coordination with the navigation application. These and other features and aspects of various embodiments are described in greater detail with respect to FIGS. 1-7 below.

FIG. 1 is diagram of a user 101 operating a vehicle 102 and using a mobile navigation device 100 according to an embodiment of the subject matter disclosed herein. As discussed briefly in the overview, the mobile navigation device 100 may have a navigation application executing thereon. As shown in FIG. 1, the mobile navigation device 100 may be temporarily mounted to a stanchion 110 seated on a dashboard 112 of the vehicle 102 in which the user 101 is operating. In other embodiments, the mobile navigation device may be freely movable, such as a handheld device, or may be integrated with the vehicle 102, such as a car stereo/navigation system.

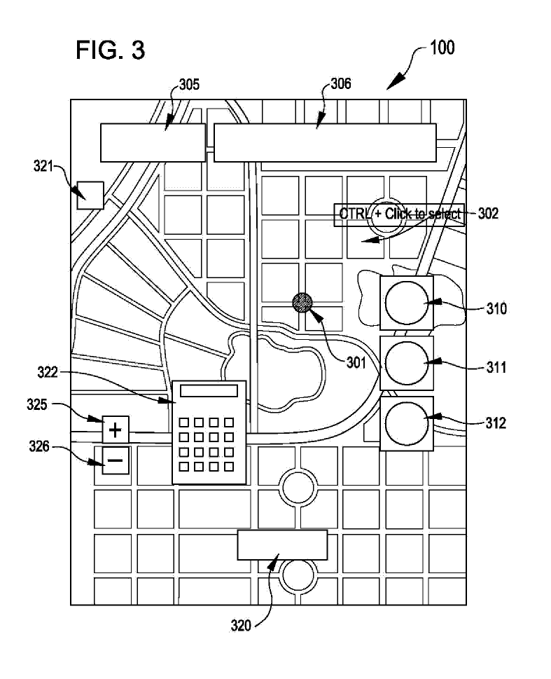

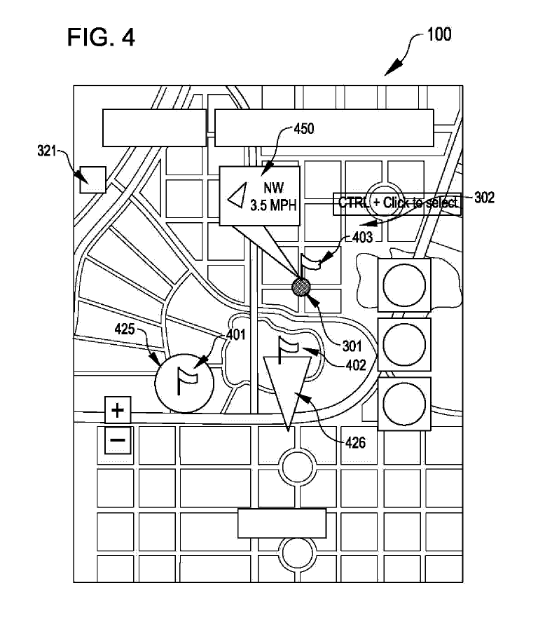

The mobile navigation device 100 may be in the form factor of a handheld or mountable tablet computing device. Thus, the tablet computing device may include a touch screen input such that software-implemented input buttons may be displayed and given functionality through application executing thereon. The tablet computing device 100 may include hardware based input actuators as well for manipulating a display 126 and other applications to get to a home screen, change the volume level or cycle the power of the tablet computing device 100. An additional input device may be a microphone 125 for receiving analog audio signals from an ambient environment (e.g., the microphone may be used to receive voice input from a user). The hardware input options and software-based input options are not shown in physical detail in FIG. 1, but are discussed in context with respect to FIGS. 3-4 below.

The mobile navigation device 100 may include a computing processor 123 that is coupled to a memory 122 through a bus (not shown). The processor 123 is configured to execute computer-executable instructions that may be stored in the memory (i.e., a computer-readable medium). Further, the processor is coupled to one or more communication modules 121 that facilitate combination of data and instructions to and from one or more networks (not shown in FIG. 1). The communication module 121 may be a satellite transceiver, a GPS transceiver, and LTE-enabled transceiver, a Wi-Fi transceiver or any other suitable communication module configured to interactively communicate with other computing device also communicating with one or more networks, such as the GPS network, the internet or and LTE-based network.

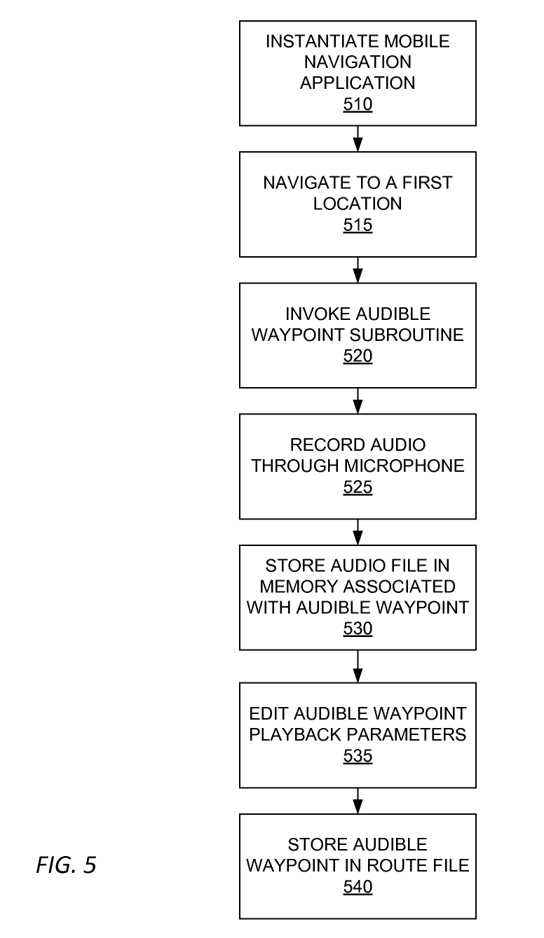

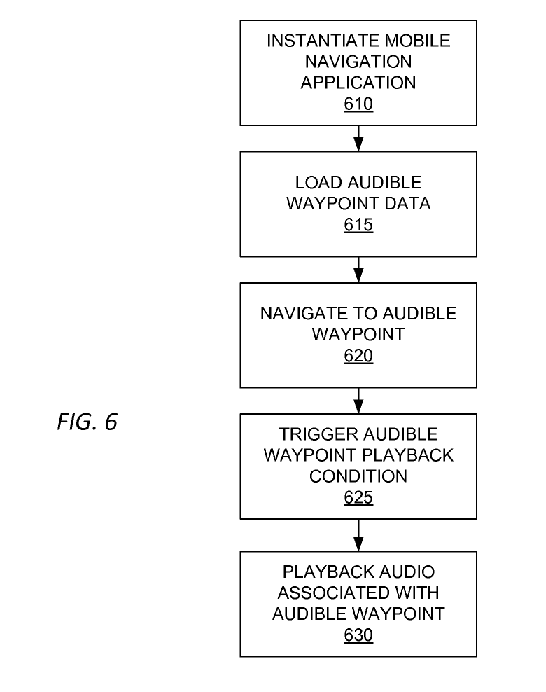

The mobile navigation device may also include output devices therein such as a display 126 for presenting visual data and information to a user. The display may also render software-based input buttons such that a user may interact with a touch screen input device to manipulate application executing on the mobile navigation device 100. Further, the mobile navigation device 100 includes an audio speaker 124 that is configured to playback audio files that may be stored in digital form in the memory 122. The digital audio files stored in the memory 122 may correspond to analog audio signals previously received and recorded through the microphone in the context of operation of an application executing on the mobile navigation device 100. Various methods of operations of this nature are discussed below with respect to FIGS. 5-6.

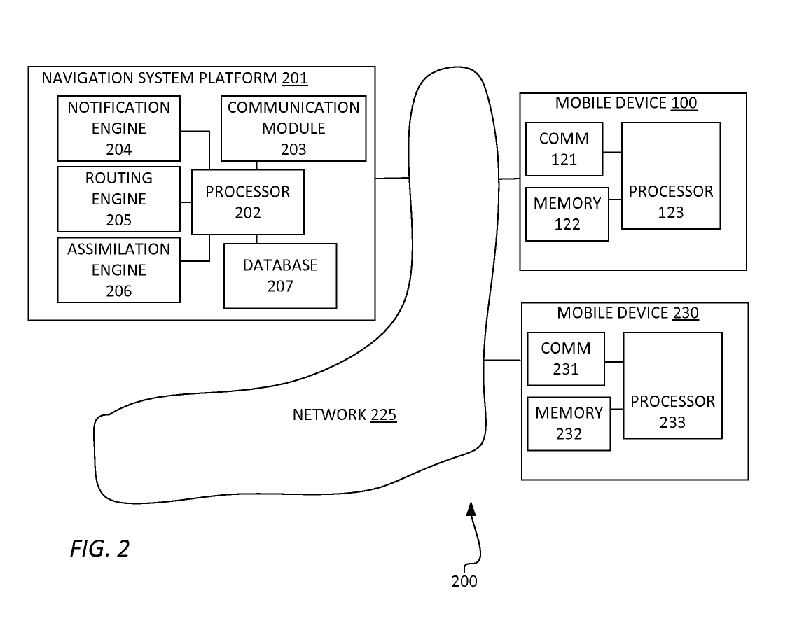

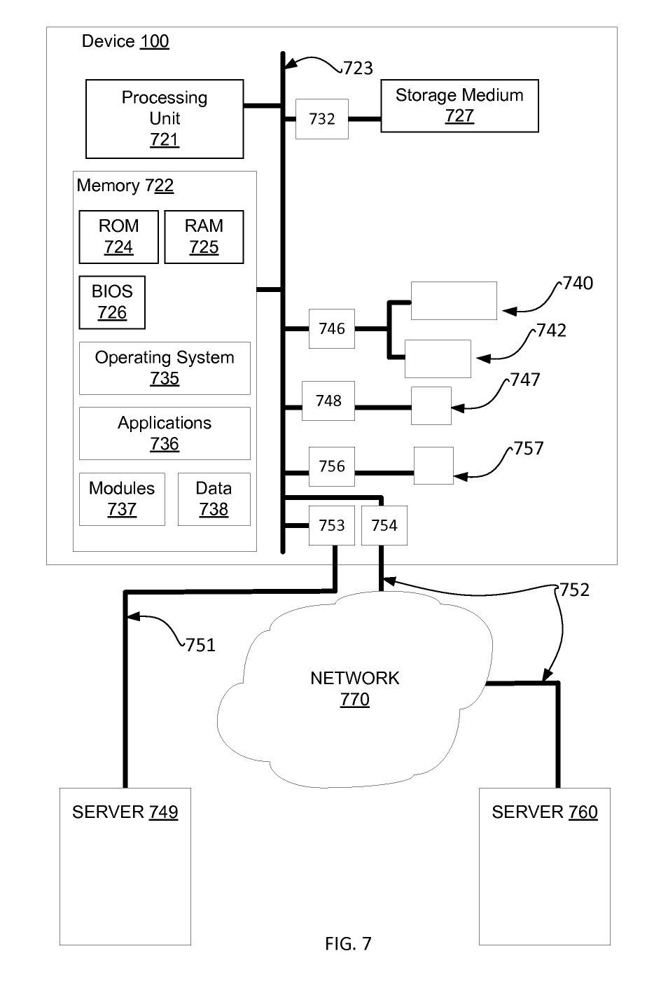

Although FIG. 1 depicts a tablet form of the mobile navigation device 100 mounted in a vehicle 102, several other embodiments are possible, but not illustrated. Such embodiments for the mobile navigation device 100 include the tablet computer as shown, a mobile phone, a smart phone, a phablet, a laptop computer, a wearable computing device, a smart eyewear device, a virtual reality computing device, a GPS device, a vehicle navigation system, vehicle radio system, and the like. Further, the vehicle shown in FIG. 1 is an automobile, but other embodiments include watercraft, aircraft, off-road vehicles, motorcycles, all-terrain vehicles, rally-style road vehicles, and the like. Further yet, the mobile navigation device 100 may be used in an isolated manner and without being in combination with a vehicle, boat, aircraft, etc. and simply be used by a user who is walking, running, racing, or otherwise engaged in other pedestrian or athletic activities. In summary, the mobile navigation device 100 of FIG. 1 may be used in the course of navigation in any context. The mobile navigation device may be any suitable computing environment as discussed in detail below with respect to FIG. 7. Thus, in the course of navigation and use, the mobile navigation device 100 may be part of a larger and more expansive navigation system that includes other computing devices in a networked environment and described next in FIG. 2.

FIG. 2 is a diagram of a suitable system 200 in which the mobile navigation device 100 of FIG. 1 may operate according to an embodiment of the subject matter discussed herein. In the context of the system 200, the mobile navigation device 100 is shown communicatively coupled to a network 225. The network 225 may include a vast number of satellites and computing devices interconnected through various communication protocols and physical layers. In an embodiment, this network 225 is only the GPS network of satellites. In other embodiments, the network 225 may be thought of as more inclusive “the Internet” and also includes Wi-Fi-based communications, LTE-based communication systems, satellite-based communication system, and any other form of analog or digital communication system in which a first computing device (such as mobile navigation device 100) may communicate and exchange data with one or more other computing devices (such as mobile navigation device 230 or server computer 201).

Thus, the mobile navigation device 100 as shown in FIG. 2 includes a communication module 121 as discussed above. This communication module may include several different transceivers for facilitating communication with one amongst the afore-mentioned communication systems. A skilled artisan understands that the communication module block 121 as shown may represent at least three separate transceivers including a LTE-network transceiver, a Wi-Fi transceiver and a satellite transceiver. Together with the processor 123 and the local memory 122, the functionality desired in the mobile navigation device may be realized. Further, other mobile navigation devices, such as mobile navigation device 230, may also be similarly configured having a communication module 231, a processor 233, and a memory 232.

Further yet, the mobile navigation device 100 may also communicate with a server computer through the network via any suitable communication system (e.g., LTE, Wi-Fi, satellite, and the like). The server computer may be a navigation system platform 201 having one or more local processors 202 coupled to one or more databases 207 configured to exchange data and information with the network 225 through one or more communication modules 203. The navigation system platform 201 may further include engines for accomplishing navigation specific tasks such as a routing engine 205 for optimizing routes between map points, a notification engine 204 for communicating with connected mobile navigation devices, and an assimilation engine 206 for adding navigation data to a database of navigation data. Other tasks and engines are contemplated but not discussed herein for brevity. Instead, a navigation application that may be executing on the mobile navigation device 100 is discussed next with respect to FIGS. 3-4.

FIG. 3 is a screen shot of a mobile navigation application executing on the mobile navigation device 100 of FIG. 1 according to an embodiment of the subject matter discussed herein. The navigation application may provide a number of features and functionality to a user of the mobile navigation device including mapping functions, routing functions, turn-by-turn directions, and the like. All aspects of a navigation application are not discussed here for brevity. As such, focus will be upon using specific navigation features in conjunction with audible waypoints. A waypoint, in the context of a navigation system, may be a reference point in physical space used for purposes of navigation—sometimes called a landmark. In a navigation application then, a waypoint may be indicated on a displayed map in the form of a marker or flag. To this end, an audible waypoint may be a waypoint associated with a specific location on the map that not only includes information about the actual location but is also associated with an audio file of the user's creation or choosing. The screen shot of FIG. 3 is such a displayed map showing various information boxes and input features allowing a user to interact with the navigation application in order to establish and use audible waypoints.

When first instantiated, a current location of the mobile navigation device 100 may be displayed as a center point 301 of an underlying map 302. The map 302 may be a satellite view, a road map view, a terrain map, custom maps, or a hybrid view showing three-dimensional representation of building or any other display that may convey location information to a user. Further, additional display boxes may show additional information about the location of the mobile navigation device 100 such as current velocity 305 and longitudinal and latitudinal coordinates 306. As the mobile navigation device 100 may be moving after the application has been instantiated, a distance display box 320 may be updated. The user may also zoom in 325 and zoom out 326 using zoom navigation buttons 325 and 326.

As the user may wish to engage various features of the mobile navigation application, a waypoint button 321 may be invoked. This will allow a user to place a waypoint (sometimes called dropping a flag or placing a marker) at the current location of the mobile navigation device 100 or any other desired location. When invoked, a pop-up menu 322 may be displayed allowing a user to place a specific kind of waypoint with a specific icon and a specific name (either selected by the user or inputted by the user with a keyboard routine or a speech-to-text routine). In other embodiments, the specific kind of waypoint may be preselected such that it is immediately invoked upon actuation and without a pop-up menu of choices. Further, the specific waypoint may be further associated with a global indicator 310, 311, or 312. These buttons/indicators may further embody implied meaning, such as red 310, yellow, 311 and green 312 corresponding to common traffic control colors. Many other features of a navigation application may be present, but not discussed for brevity. Attention is turned to establishing and using audible waypoints within a navigation application executing on a mobile navigation device 100 next with respect to FIG. 4.

FIG. 4 is a screen shot of a mobile navigation application executing on the mobile navigation device 100 of FIG. 1 showing audible waypoint markers according to an embodiment of the subject matter discussed herein. As discussed above a user may place waypoints/markers at any location on the map 302 in the mobile navigation application. This may assist with creating and navigating routes for running, biking or driving. In FIG. 4, there are shown three such waypoints 401, 402, and 403. A user may use the mobile navigation application to plan, build, and edit routes and utilize various waypoints along the planned route. The user has the option of establishing and/or deleting audible waypoints or non-audible waypoints to build the route. Further, as a user is on the route, the user may establish waypoints in real-time by actuating the dropping of waypoints at a current location of the mobile navigation device 100 by pressing a waypoint drop actuator 321 displayed on the display of the mobile navigation device 100.

In an embodiment that uses audible waypoints, the user may also generate and/or record audio information that may be associated with the dropped audible waypoint 403. Thus, as a user drops an audible waypoint 403 while navigating, an audio recording routine is invoked such that a specific period of time is recorded after the dropping of the audible waypoint. The recording of audio may be accomplished through a microphone such that analog audio signals (i.e., the user's voice propagating through the air) is captured and stored in a digital audio file in a memory of the mobile navigation device 100. The digital audio file may be a speech-to-text rendition of the received audio signals at the microphone. In other embodiments, the digital audio file may an audio rendering of the actual analog signals (e.g., a wave file or MP3 file). A user may speak a message to be recorded in said digital audio file such that the audio file is then associated with the dropped audible waypoint 403. A typical period of time for recording may be five seconds, however shorter or longer times are possible in other embodiments. The user may then listen to any audio file associated with the audible waypoint 403 at any time by accessing the file or may establish a specific time to playback the audio when a specific condition is met. Such specific conditions are discussed next.

One such condition may simply be that an audio file is played back when the mobile navigation device 100 next navigates to the coordinates of the audible waypoint 403. In another condition, an audible waypoint 401 may be associated with a proximity ring 425. Such a proximity ring 425 may be defined by a uniform distance from the coordinates of an audible waypoint 401. Thus, when the mobile navigation device 100 moves to within this range, the associated audio file may be played back.

As shown in FIG. 4, the proximity ring 425 may be displayed around an upcoming audible waypoint to indicate when audio playback will be provided as a user navigates the route. Such a proximity ring 425 may also be dynamic in that the range may be automatically resized as the speed of the mobile navigation device 100 changes to allow for sufficient time for audio playback. Further an additional feature of the navigation application may include a speed slider mode that provides for a user to proactively control the size of the proximity rings with a slider control. If the setting of this feature is on automatic, the proximity rings will resize based on the current speed of travel. This feature may also be invoked by voice prompt. Specific settings may also be set such as (a) on foot: less than 5 mph, (b) biking: 5 mph up to 30 mph, (c) vehicle: 30 mph up to 75 mph, and (d) racing: 75 mph or more. Further yet, the color of the displayed proximity ring 425 may change based on the speed of the device or based upon an assigned importance of the proximity ring.

The proximity rings need not be uniform in other embodiments. For example, the proximity ring 426 associated with the audible waypoint 402 is triangular such that if the mobile navigation device is approaching from a specific direction, the audio file is played back sooner. This proves useful for alerting the user to the audio playback sooner if the approach is a racing approach (e.g., tip of the triangle) as opposed to a scouting approach, such as from one of the leg sides of the isosceles triangle. Any non-uniform proximity ring may be realized for individual audible waypoints.

Further a playback navigation feature may invoke playing back a user's comments at a given location based on what they personally recorded while pre-running said location. Playback of a personal voice recording or text-to-speech file may be based on GPS coordinates. When using navigation applications on mobile navigation devices in off-road and backcountry environments, playing back a user's voice recorded comments at specific GPS coordinates based on what they personally voice recorded while pre-running/planning that route. The voice comments/notes may be played at the appropriate times as they navigate the route. Other navigation applications may not play personal voice recordings or speech-to-text files at specific GPS coordinates while navigating.

Further yet, another playback feature may include use of a “dummy” audio file designed to keep a BlueTooth™ connection active on a mobile navigation device. With certain systems in place that utilize speakers for audio playback that are communicatively coupled to the mobile navigation device 100 through a short-range communication protocol, such as BlueTooth™, the actual communication connection may phase in and out of connectivity due to inactivity. Thus, in a fast-paced situation (e.g., a rally race), the time necessary to negotiate the communication connection again may prevent the audio file from being played back at the appropriate time with respect to an upcoming audible waypoint. To prevent an audio file from not being played properly during navigation, a silent stream of audio (i.e., an audio file of silence) is continuously played back repetitively to maintain a BlueTooth™ connection with various BlueTooth™ devices. Such a silent audio file may be very short such that playback ends at regular short intervals if a proper audio file associated with an audible waypoint needs to be invoked straight away. This method prevents portions of audio from being clipped off or being played back in an untimely manner due to different wakeup times between various BlueTooth™ enabled devices.

Another feature includes a music volume setting slider. Music (either being played back by the mobile navigation device 100 itself or by a system communicatively coupled to the mobile navigation device 100) may be lowered when the navigation audio is in use, but then be returned to the selected volume after audio file playback.

The mobile navigation application may include different voicing options, such as Siri™ voice, Cortana™ voice, male voice, and female voice options for non-recorded audio playback and/or navigation features. Voice packs may also be used in the application where themed voice packs will be compiled with various voices for various occasions.

The navigation application includes features for counting and audibly stating laps completed, reversing routes, combining two or more routes, ability to pass the finish/starting point on looping routes and continue to navigate the loop until the desired number of laps has been met, splicing routes, breaking up routes and generally allowing for additional navigation features associated with the newly modified routes. Further, any route may be invoked with intelligent route capture. This feature may determine visual and audio prompts on the fly after completing a first lap. A refinement may be made after the following laps. Such refinements are based off of the speed and angles that are being recorded. The application features an ability to see the list of waypoints in the route. Each waypoint may show the distance to it from the previous waypoint, the type of turn or waypoint, and the bearing to it (N, NE, S, SW, and the like). A user may select current route, view waypoint list, and the list may be displayed from their current location to the end.

Once a route is recorded or planned or if a route has been manipulated, the user may playback the route navigation at any chosen speed and may invoke the audio recorded messages when the audible waypoints or markers are encountered. The playback speed may be varied during the playback as well. Further, during a playback of the route, the audio may automatically play back if the user is within a specified range of the original waypoint or marker location.

The application may have a feature for adding camera images to be associated with a waypoint, e.g., a visual waypoint. Further, adding a visual waypoint may automatically invoke an image capture device within (or communicatively coupled with) the mobile navigation device. Such an image may be displayed on the display of the mobile navigation device 100 or on a communicatively coupled separate display device.

An additional feature of the navigation application may be the use of a navigation halo 450. The navigation halo 450 may be a user interface that is created when layering a compass feature, a directional line feature, and a feature for an upcoming turn warning image or notification image for a specified GPS coordinate in a heads-up display (HUD) configuration. The navigation halo 450 shows basic information to a user. This configuration preserves valuable screen space that traditionally would have taken up screen space for each feature independently. Thus, the functionality of different features may be combined into one mechanism. There are several other features of the mobile navigation application as discussed below.

A rally navigation feature allows for rally style turn warnings audibly and visually, such as slight right, hard right, and the like. When using a mobile navigation device 100 off-road or in backcountry locations, visual and audible advance notifications of turns other than the standard 90 degree turns related to street navigation. Examples include slight right, right, hard right, slight left, left, hard left, danger, wash/river, bumpy, rough, rut, rocky, and the like. These notifications are provided as the user navigates a route for a specified GPS coordinate in a heads up display (HUD) configuration. This concept provides notifications that are not offered by a traditional street GPS navigation system. Additional features of a navigation application are contemplated but not discussed herein for brevity. Methods for using the mobile navigation device 100 of FIGS. 1-4 are discussed next.

FIG. 5 is a flow chart of a method for operating the mobile navigation device of FIG. 1 to establish an audible waypoint according to an embodiment of the subject matter discussed herein. In this method, a user may be operating the mobile navigation device 100 of FIG. 1 wherein a navigation application is configured to be executed thereon. Thus, at step 510, the user may instantiate the navigation application and navigate to a first location at step 515. Such a first location may be exactly where the user invoked the navigation application or may be some time later after walking, running, biking or driving to a desired physical location. The first location may be further associated with a specific global position in the context of a GPS system and therefore includes a specific set of longitudinal and latitudinal coordinates. Such a first location may further include an elevation as well for three dimensions of accuracy.

At the first location, the user may invoke an audible waypoint subroutine at step 520 by actuating an audible waypoint input button or speaking a voice command to prompt the dropping of an audible waypoint. When the navigation application receives an input to invoke the audible waypoint subroutine, a microphone is engaged at step 525 such that audio signals are recorded for a specific duration of time (e.g., five seconds). This allows a user to speak a message for the duration of time being recorded in order to capture thoughts that the user may have about the audible waypoint. Such examples of these thoughts may be instructions such as, “ease up over the hill” or “punch it hard around the bend” or any other message a user may wish to associate with an audible waypoint.

Once the duration of time ends, any captured audio is then stored in a digital audio file, at step 530, in a memory in the mobile navigation device 100. The digital audio file may be a digital rendering of the actual audio or may be a speech-to-text rendering of the speech from the user. The user may then establish or edit specific parameters about the audio file such as playback speed, playback volume, proximity ring trigger, and the like at step 535. The audio file, its playback parameters and the audible waypoint are then associated with each other and stored in the context of route in the memory of the mobile navigation device 100 at step 540. The method of FIG. 5 may be repeated for other locations as well such that multiple locations may be associated with multiple audible waypoints.

FIG. 6 is a flow chart of a method for operating the mobile navigation device of FIG. 1 to invoke an audible waypoint according to an embodiment of the subject matter discussed herein. In this method, a user may be operating the mobile navigation device 100 of FIG. 1 wherein a navigation application is configured to be executed thereon. Thus, at step 610, the user may instantiate the navigation application and load route data, waypoint data, audible waypoint data and the like. In this manner, previously established audible waypoints may be loaded and ready to execute when triggered by a condition. The data is loaded at step 615 in terms of this method; such a loading step may simply be executing the navigation application in such a way that audible waypoints are ready to be accessed from the memory in which said audible waypoints are stored. In other embodiments, the loading may include retrieval of audible waypoint data from a remote data storage communicatively coupled to the mobile navigation device 100 via a computer network 225.

At step 620, the user may navigate to a location of an audible waypoint. Such navigation may involve running, walking, biking, driving, sailing, and the like. The audible waypoint may be associated with a trigger condition as well. Thus, as the mobile navigation device 100 approaches the physical location of the audible waypoint, the audible waypoint may be associated with a proximity ring, such as described with respect to FIG. 4. Navigating the mobile navigation device to a location within the proximity ring of an audible waypoint may be a trigger condition for playing back the audio file. Other trigger conditions may exist, such as breaching a proximity ring at a speed that is at least a minimum speed or breaching a proximity ring from a specific direction.

Once the trigger condition is met, the audio file may be played back at step 630. The audio playback may be through one or more speakers that are integral with the mobile navigation device 100. In other embodiments, the speakers used for audio playback may be in a vehicle as the vehicle's audio, navigation and entertainment system such that the audio file is streamed to the communicatively coupled vehicle system. Such a commutative coupling (e.g., BlueTooth™, as but one example) is suited to facilitate wirelessly communicating the audio file (which is a stored set of recorded analog signals) to an audio playback device and playing back the audio file at the playback device.

FIG. 7 and the following discussion are intended to provide a brief, general description of a suitable computing environment in which the subject matter disclosed herein may be implemented. Although not required, aspects of the systems and methods described herein may be practiced in the general context of computer-executable instructions, such as program modules, being executed by a computer device. Generally, program modules include routines, programs, objects, components, data structures, and the like, that perform particular tasks or implement particular abstract data types. Such program module may be embodied in both a transitory and/or a non-transitory computer readable medium having computer-executable instructions. Moreover, those skilled in the art will appreciate that the systems and methods herein may be practiced with other computer system configurations, including hand-held devices, smart watches, cellular or mobile telephones, smart phones, smart tablets, multiprocessor systems, microprocessor-based or programmable consumer electronics, network personal computers, minicomputers, mainframe computers, distributed computing systems, cloud computing systems, and the like. The systems and methods herein may be practiced in distributed computing environments where tasks are performed by remote processing devices that are linked through a communications network. In a distributed computing environment, program modules may be located in both local and remote computing devices.

With reference to FIG. 7, an exemplary computing environment for implementing the systems and methods disclosed herein includes a general purpose computing device in the form of a mobile navigation device 100, including a processing unit 721, a system memory 722, and a system bus 723 that couples various system components including the system memory to the processing unit 721. The system bus 723 may be any of several types of bus structures including a memory bus or memory controller, a peripheral bus, and a local bus using any of a variety of bus architectures.

The system memory includes read only memory (ROM) 724 and random access memory (RAM) 725. A basic input/output system (BIOS) 726, containing the basic routines that help to transfer information between elements within the mobile navigation device 100, such as during start-up, is stored in ROM 724. The mobile navigation device 100 further includes a storage medium 727 for reading from and writing data to a computer-readable storage medium. The storage medium 727 is connected to the system bus 723 by an interface 732. Such computer-readable media provide nonvolatile storage of computer readable instructions, data structures, program modules and other data for the mobile navigation device 100. A number of program modules may be stored in memory 722 or on the storage medium 727, including an operating system 735, one or more application programs 736, other program modules 737, and program data 738. A user may enter commands and information into the personal computer 100 through input devices such as a keyboard 740 and pointing device 742. A display 747 is also connected to the system bus 723 via an interface, such as a video adapter 748. One or more speakers 757 are also connected to the system bus 723 via an interface, such as an audio adapter 756. Further, a global positioning system component may also be coupled to the system bus 723.

The mobile navigation device 100 may also operate in a networked environment using logical connections to one or more remote computers, such as remote computers 749 and 760. Each remote computer 749 or 760 may be another mobile navigation device, a personal computer, a server, a router, a network PC, a peer device or other common network node, and typically includes many or all of the elements described above relative to the mobile navigation device 100.

The logical connections depicted in FIG. 7 include a local area network (LAN) 751 and a wide area network (WAN) 752, which may also include a wired and/or wireless network 773 including but not limited to the World Wide Web, a cloud based public or private network, a GPS satellite based network, a Global System for Mobile (GSM) network, a Long Term Evolution (LTE) network, and a Code Division Multiple Access (CDMA) network. Such networking environments are commonplace in offices, enterprise-wide computer networks, intranets, Internet, satellite based networks, and the mobile networks.

As depicted in FIG. 7, the remote computer 749 communicates with the mobile navigation device 100 via the local area network 751. The mobile navigation device 760 communicates with the mobile navigation device 100 via the wide area network 752. The remote computer 760 communicates with the mobile navigation device 100 via the wireless network.

When used in a LAN networking environment, the mobile navigation device 100 is connected to the local network 751 through a network interface or adapter 753. When used in a WAN networking environment, the mobile navigation device 100 typically includes a wireless communication port 754, Network Interface Card (NIC) or other means for establishing communications over the wide area network 752, such as the Internet or wireless broadband network. The wireless communication port 754, which may be internal or external, is connected to the system bus 723. In a networked environment, program modules depicted relative to the mobile navigation device 100, or portions thereof, may be stored in the remote memory storage device. It will be appreciated that the network connections shown are exemplary and other means of establishing a communications link between the computers may be used.

As briefly discussed above, the mobile navigation device 100 may include a number of applications stored therein that are configured to execute on the mobile navigation device and to utilize the various components and resources of the mobile navigation device 100 or other computers communicatively coupled to the mobile navigation device via one or more networks. One such application discussed throughout this disclosure is a mobile device navigation application. As with any computing device, a user may invoke execution of an application by engaging the application via some form of input (e.g., finger tap, voice command, and the like). As the application begins to execute, various instantiations of computing modules may be executed by the processing modules of the mobile navigation device 100. Such computing modules of the application may include a mapping engine, a global position system engine, an audio features engine, a heads up display overlay engine; and other computing modules that give rise to the features of the application as discussed below. To this end, these computing modules give functionality to user-driven manipulations such as building and navigating routes, recording tracks, and dropping markers.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A mobile navigation device, comprising:
a memory having computer-executable instructions stored therein;
a processor coupled to the memory and configured to process the computer-executable instructions stored in the memory;
a display coupled to the processor and configured to display a navigation screen showing a navigation position of the mobile navigation device during execution of a navigation application by the processor;
a microphone coupled to the processor and configured to receive analog audio signals such that the processor is configured to store one or more recorded analog audio signals an audio file in the memory; and
an audio output coupled to the processor and configured to playback the audio file in coordination with the navigation application.

2. The mobile navigation device of claim 1, further comprising a communication module configured to send and receive GPS signals to and from an GPS communication network.

3. The mobile navigation device of claim 1, further comprising a communication module configured to send and receive Wi-Fi signals to and from a Wi-Fi network.

4. The mobile navigation device of claim 1, further comprising an input actuator configured to be actuated by a user and when actuated causes the navigation application to establish an audible waypoint and causes the processor to engage the microphone to begin receiving analog audio signals that when recorded become the audio file.

5. The mobile navigation device of claim 1, wherein the coordination with the navigation application further comprises associating the audio file with an audible waypoint established by a user.

6. The mobile navigation device of claim 5, wherein the processor is further configured to playback the audio file if the mobile navigation device moves within a defined proximity of the audible waypoint.

7. The mobile navigation device of claim 1, wherein the audio file comprises a personal message recorded by a user of the mobile navigation device, the audio file approximately five seconds in length.

8. The mobile navigation device of claim 1, wherein the processor is further configured to playback the audio file if the mobile navigation device moves within a defined proximity of a set of global position system coordinates.

9. The mobile navigation device of claim 1, wherein the navigation application further comprises a non-real-time playback mode wherein a navigation route may be displayed in a non-real-time playback such that the recorded audio file is played back at a specific time during the non-real-time playback.

10. A system, comprising:
a first computing device, having:
a memory having computer-executable instructions stored therein;
a first processor coupled to the memory and configured to process the computer-executable instructions stored in the memory;
a display coupled to the processor and configured to display a navigation screen showing a navigation position of the mobile navigation device during execution of a navigation application by the processor;
a microphone coupled to the processor and configured to receive analog audio signals such that the processor is configured to store one or more recorded analog audio signals an audio file in the memory; and
a first communication module configured to communicate with one or more other computing devices; and
a second computing device, having
a second processor;
a second communication module configured to communicate with one or more other computing devices including the first mobile navigation device; and
an audio output coupled to the second processor and configured to playback the audio file in coordination with the navigation application.

11. The system of claim 10, wherein the first communication module communicates with the second communication module through a Wi-Fi enabled communication connection.

12. The system of claim 10, wherein the first communication module communicates with the second communication module through a BlueTooth™ enabled communication connection.

13. The system of claim 10, wherein the first communication module communicates with the second communication module through a physical analog communication connection.

14. The system of claim 10, further comprising a vehicular audio and navigation system.

15. The system of claim 10, further comprising one of the group comprised of: a tablet computer; a mobile phone, a phablet, a laptop computer, a wearable computing device, a GPS device, and vehicle radio system.

16. The system of claim 10, wherein the first processor is further configured to continuously playback an audio file comprising silence such that communication between the first communication module and the second communication module is continuously maintained.

17. A method, comprising:
navigating a mobile navigation device to a first location;
establishing an audible waypoint at the first location;
recording a first set of analog signals received through a microphone for a duration of time in response to the establishing of the audible waypoint; and
storing a rendering of the first set of recorded analog signals in association with the audible waypoint in a memory coupled to the mobile navigation device.

18. The method of claim 17, further comprising playing back the rendering of the first set of recorded analog signals in response to navigating the mobile navigation device to the first location a second time.

19. The method of claim 17, further comprising:
wirelessly communicating the stored rendering of the set of recorded analog signals to an audio playback device; and
playing back the rendering of the first set of recorded analog signals at the playback device.

20. The method of claim 17, further comprising:
navigating the mobile navigation device to a second location;
establishing a second audible waypoint at the second location;
recording a second set of analog signals received through the microphone for a duration of time in response to the establishing of the second audible waypoint; and
storing a second rendering of the second set of recorded analog signals in association with the second audible waypoint in the memory.
